(19) United States
(12) Patent Application Publication
(10) Pub. No.: US 2008/0055409 A1
(43) Pub. Date: Mar. 6, 2008

(54) Surveillance Camera System

(75) Inventors: Jeff Mars, Huntington Station, NY (US); Joseph Savettiere, N. Babylon, NY (US); Xianping Ren, Brooklyn, NY (US); Mark Fakelmann, Point Lookout, NY (US); Yacov Pshtissky, Bayside, NY (US); Rein S. Randmac, Ft. Solonga, NY (US)

Correspondence Address: DARBY & DARBY P.C., P.O. BOX 770, Church Street Station, New York, NY, 10008-0770, US

(73) Assignee: Vicon Industries Inc., Hauppauge, NY (US)

(21) Appl. No.: 11/572,537

(22) PCT Filed: Jul. 22, 2005
(86) PCT No.: PCT/US05/26060

§ 371 Date: Apr. 3, 2007

Related U.S. Application Data
(60) Provisional application No. 60/590,505, filed on Jul. 23, 2004.

(51) Int. Cl. H04N 7/18

(52) U.S. Cl. 348/143; 348/E07.085

(57) ABSTRACT

A surveillance camera system capable of accepting any appropriate surveillance camera and video transmission option and is programmed to operate with a multitude of competitive communication protocols with minimal servicing required. The system can quickly convert and/or update the camera system to be able to transmit video data over coaxial cable, unshielded twisted-pair (UTP), fiber optics or IP. A conversion from UTP to IP can convert the camera assembly into a network server for TCP/IP communication enabling the camera to be controlled locally or from any location over the internet using any installed network video protocol. The camera assembly with the ability to quickly configure the communication video interface via switch selectable on-board communication protocols.

### FIELD OF THE INVENTION

The present invention relates to a surveillance camera system and, more particularly, to surveillance cameras for use with closed-circuit television systems, such as for indoor or outdoor store security, building security, and any other security or monitoring applications.

### BACKGROUND OF THE INVENTION

Surveillance camera systems are commonly used to monitor various areas, such as cashier windows, store parking lots or gambling tables at a casino. Typically, an operator of such a surveillance system is located at a central location from which he controls one or more camera units that are remotely positioned throughout the area to be monitored. The remote units are often mounted in hemispherical domes that are suspended from the ceiling of the monitored area. By using a keyboard console, the operator selects images from the remote cameras to be displayed on one or more video monitors. Some systems include a joy stick on the control console to permit the operator to reposition a camera in order to obtain a better view of a particular zone of observation. Prior art surveillance cameras also have operated in operator selectable automatic pan modes in order to provide full, continuous coverage of areas of surveillance. Generally, such cameras have been of the continuous scan type which pan or oscillate through an arc continuously at a fixed speed until stopped by an operator.

A disadvantage of the known surveillance camera systems relates to the difficulty of installing, updating and servicing the systems. More specifically, the prior art surveillance camera systems have been complex electromechanical structures and when servicing was required, it would usually require removal and reconfiguration of the entire structure which was not always an easy, time-effective procedure. Furthermore, a building in or about which the remote camera units are deployed may have varying data transmission systems in place for transmitting video data. For example, the buildings may be pre-wired for video for transmitting video data. For example, the buildings may be pre-wired for video transmission over fiber-optics, coaxial cable, twisted-pair or TCP/IP (several of which also have the ability to work with various competitive protocols). Prior surveillance camera systems leave something to be desired in accommodating such variations in data transmission and protocols associated with each transmission system. Further still, in many cases, whereas known surveillance camera systems provide for competitors protocols integral in their respective domes, this capability has been provided through the use of module upgrades. Because such protocols are usually contained in the main control board above the camera, upgrading video protocols commonly requires disconnecting the camera and drive motors from the system and replacing the main control board.

It would be desirable to provide such a camera in a aesthetically pleasing, compact dome type housing, with the camera and its associated electronics being readily accessible and easily removable as a unit from its housing for upgrading connections and associated communication protocols.

### SUMMARY OF THE INVENTION

The present invention overcomes the disadvantages of the prior art by providing a surveillance camera system which is easy to install, upgrade and maintain, will accept any appropriate surveillance camera and video transmission option and is programmed to operate with a multitude of competitive communication protocols with minimal servicing required.

The system is particularly advantageous in its ability to quickly convert and/or update the camera system to be able to transmit video data over coaxial cable, unshielded twisted-pair (UTP), fiber optics or IP. A conversion from UTP to IP can convert the camera assembly into a network server for TCP/IP communication enabling the camera to be controlled locally or from any location over the internet using any installed network video protocol.

Another significant aspect and feature of the present invention is a camera assembly with the ability to quickly configure the communication/video interface via switch selectable on-board communication protocols.

According to another aspect and feature, a single video communication board included in the surveillance camera system can be configured to support a plurality of communications/video interfaces. Alternatively, a video communication board configured for operation with a single video interface can be easily removed and replaced for a communication board with a different communications/video option. The video interface board is pivotally mounted to allow easy access and quick configuration of multiple communication/video interfaces. In a locked position the interface board rests securely against the top wall of the camera housing, while in an unlocked position the interface board can be pivoted to a vertical position where it is exposed to the user for connection with an appropriate video interface.

These and further aspects, features and advantages of the present invention will become more apparent from the following description when taken in connection with the accompanying drawings which show, for purposes of illustration only, several embodiments of the present invention.

### BRIEF DESCRIPTION OF THE DRAWINGS

FIG. 1 is an exploded perspective view of the major components of an indoor television camera system enclosed in a dome shaped case of the present invention;

FIG. 2 is a top perspective view of a ceiling mount for use with the system in FIG. 1;

FIG. 3A shows in detail a partial cross sectional view of the housing of an indoor camera system of FIG. 1;

FIG. 3B shows in detail a front elevation view of the housing of an indoor camera system of FIG. 1;

FIG. 4A shows in detail a bottom plan view of the housing of an indoor camera system of FIG. 1;

FIG. 4B shows in detail a top plan view of the housing of an indoor camera system of FIG. 1;

FIG. 5A is a top plan view of a segment of the camera system that includes the camera drive apparatus;

FIG. 5B is a front elevation view of a segment of the camera system that includes the camera and camera drive apparatus;

FIG. 5C is a left side elevation view of a segment of the camera system that includes the camera and camera drive apparatus;

FIGS. 6A-6B are top front perspective and front elevation views, respectively, of a video interface board according to a first embodiment of the invention;

FIGS. 7A-7B are top front perspective and front elevation views, respectively, of a video interface board according to a second embodiment of the invention;

FIGS. 8A-8B are top front perspective and front elevation views, respectively, of the video interface board of FIG. 7A incorporating a fiber optics module;

FIGS. 9A-9B are top front perspective and front elevation views, respectively, of a video interface board according to a third embodiment of the invention;

FIGS. 10A-10B are top front perspective and front elevation views, respectively, of a video interface board according to a forth embodiment of the invention;

FIG. 11 is a front perspective view showing the details of a camera positioning mechanism according to a preferred embodiment of the invention;

FIGS. 12A-12B are top left perspective and rear right perspective views, respectively, of an optional heater module incorporated in a camera system of the present invention;

FIG. 12C is a cross sectional view of an optional heater module incorporated in a camera system of the present invention;

FIG. 13 is a cross sectional view of the heater module of FIG. 12C taken essentially along the line 13-13;

FIGS. 14A-14C are top plan, front elevation, and bottom plan views, respectively, of a pan or tilt motor according to the preferred embodiment;

FIG. 15 is an exploded elevation view of the major components of an indoor television camera system enclosed in a dome shaped case of the present invention;

FIG. 16 is an exploded elevation view of the major components of an outdoor television camera system enclosed in an outdoor cover;

FIG. 17 is a top right perspective view showing camera orientation within the camera system;

FIG. 18 is a top front perspective view of an outdoor cover of FIG. 16.

FIG. 19 is a partial cross sectional view of the outdoor cover of FIG. 18;

FIG. 19A is an enlarged cross sectional view showing the circled portion of FIG. 19;

FIGS. 20-21 illustrate in diagrammatic views the manner in which a privacy mask is established on an on screen display for a surveillance camera system according the present invention; and

FIG. 22 illustrates in diagrammatic view a menu interface for controlling the operation and configuration of the privacy masks shown in FIGS. 20-21.

### DETAILED DESCRIPTION OF PREFERRED EMBODIMENTS

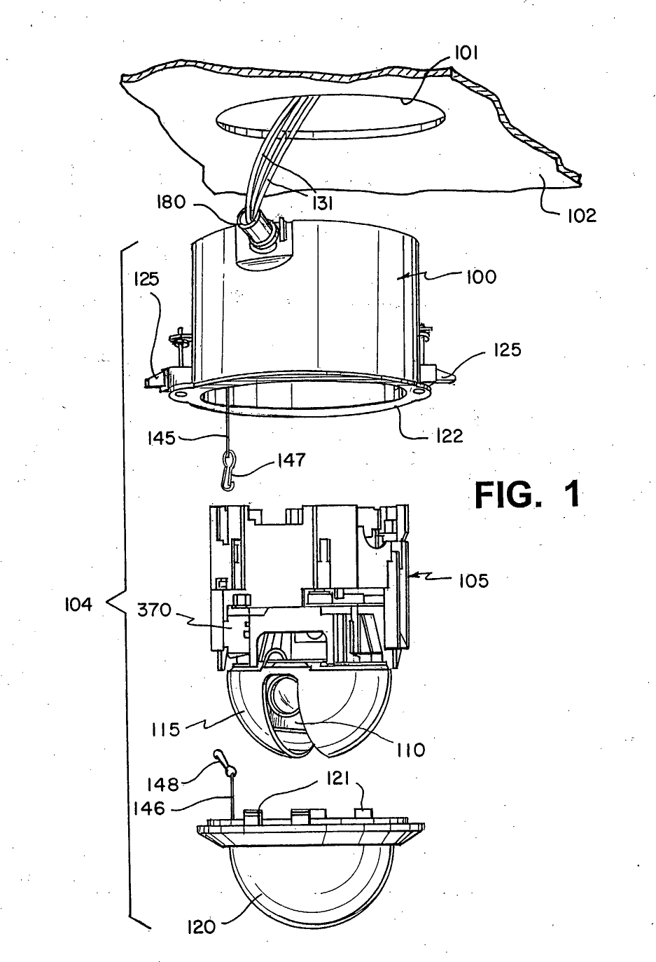

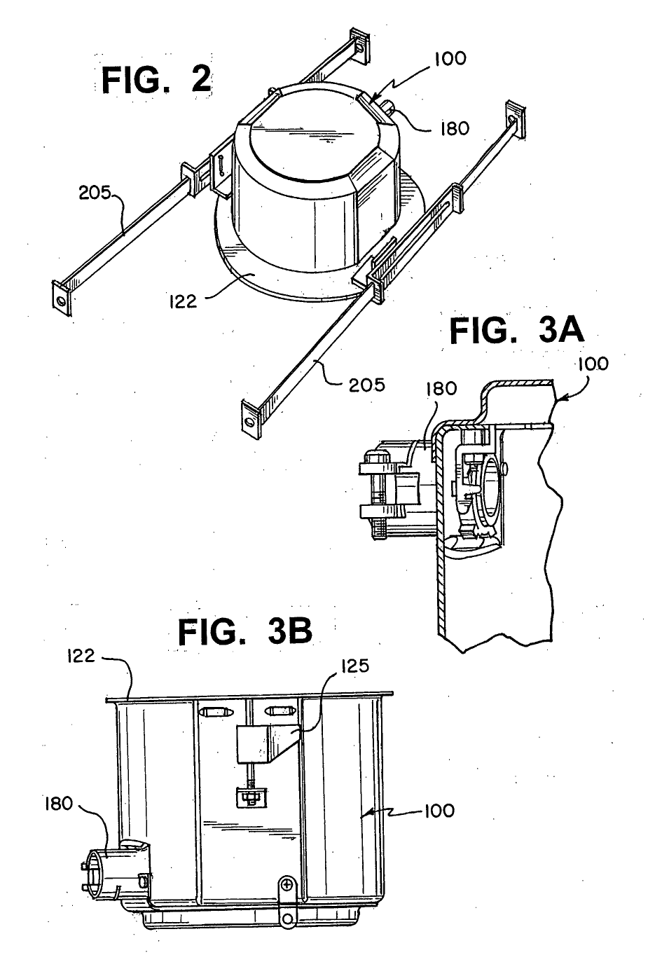

Referring to FIG. 1, a surveillance camera system 104 according to the present invention comprises housing 100, camera drive 105, video camera 110, shroud 115 and dome 120. Housing 100 encloses the components of the surveillance camera system 104 above the ceiling. Preferably, surveillance camera system 104 is installed into an orifice 101 of an existing ceiling 102 in the area to be monitored and rests on the inner ceiling surface occupying the space between ceiling 102 and the upper building frame (not shown). During installation, housing 100 is lifted up through orifice 101 and a pair of locking flippers 125 are secured against ceiling 102 thereby securing housing 100 to ceiling 102. If necessary, additional support for housing 100, other than the ceiling 102 material, can be provided through the use of optional support rails 205, as shown in FIG. 2. Support rails 205 can be formed at one end to be attached to housing 100 and at the other end to be attached onto an inner surface of ceiling 102, essentially acting to distribute some of the weight of camera system 104 along the length of rails 205 and the contacted ceiling portion. An additional mounting ring 122 may be provided between rails 205 and housing 100 for further support and distribution of the weight assembly 104 or to assist in connecting rails 205 to housing 100. Dome 120 is a hemispherical, translucent dome preferably formed of an acrylic material and extends below ceiling 102 enclosing camera 110 and shroud 115.

By way of overview, camera 110 of surveillance camera system 104 captures real-time images of a selected area and transmits the images to a remote operating consol, or possibly to multiple monitoring stations, for viewing by an operator. A number of surveillance camera systems 104 may be located at strategic locations throughout the monitored area to provide multiple views of the area to the remote operating consol. Synchronization of sync signals from several remotely spaced cameras providing a remote operator the ability to split a screen display between the output of several cameras is discussed in U.S. Pat. No. 4,860,101, entitled Central Station Synchronization System.

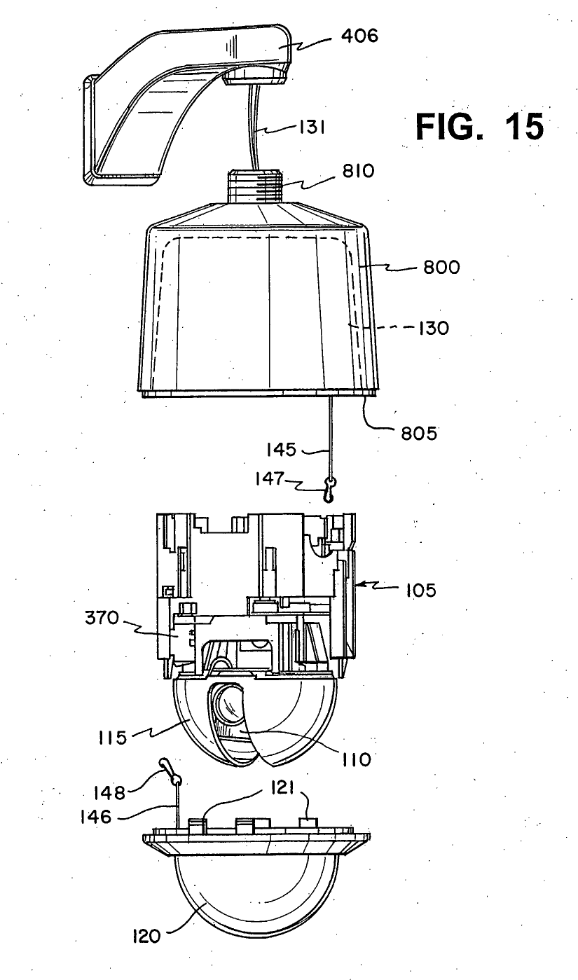

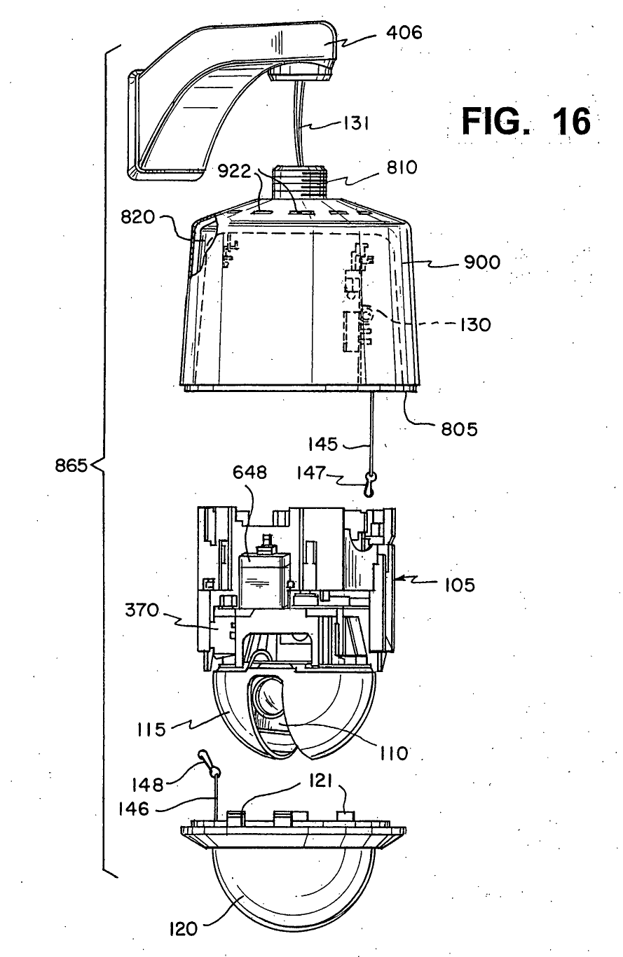

Referring to FIG. 1, surveillance camera system 104 includes a customer interface board 130 (shown best in FIGS. 15 and 16) pivotally mounted in the top of housing 100, that can be pivoted and removed if desired for easy access to video connectors. As described in further detail below, wiring is provided to the customer interface board 130 through orifice 101 for propagating power, video, control and other signals to camera 110. Optional wiring can be installed for use in relay output and alarm inputs. Additional wiring connecting camera 110 to an appropriate video interface can be accomplished through connection with customer interface board 130. Cables 131 for all wirings to customer interface board 130 are routed from above ceiling 102 through conduit 180 of housing 100.

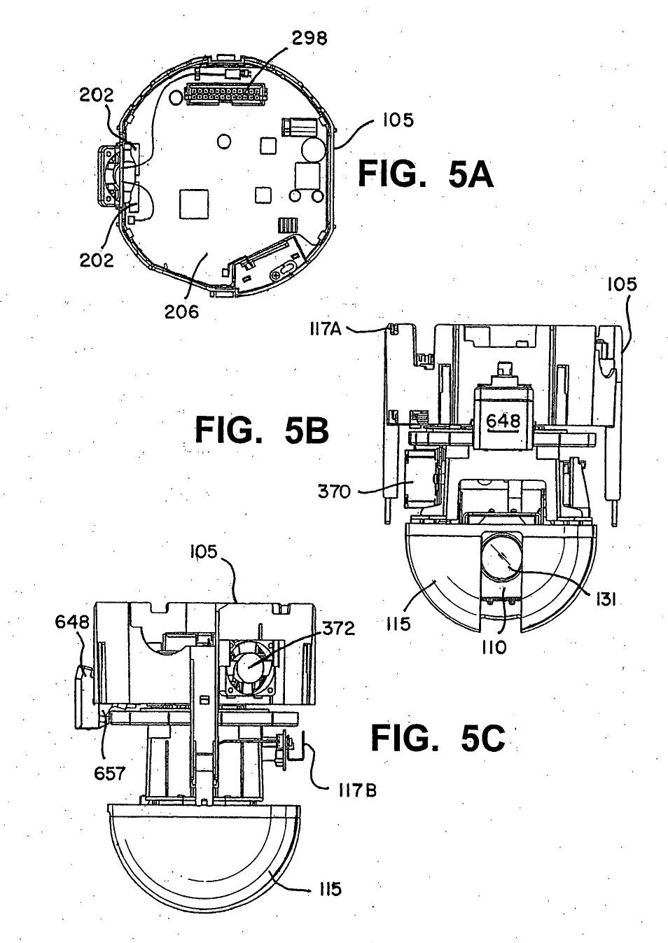

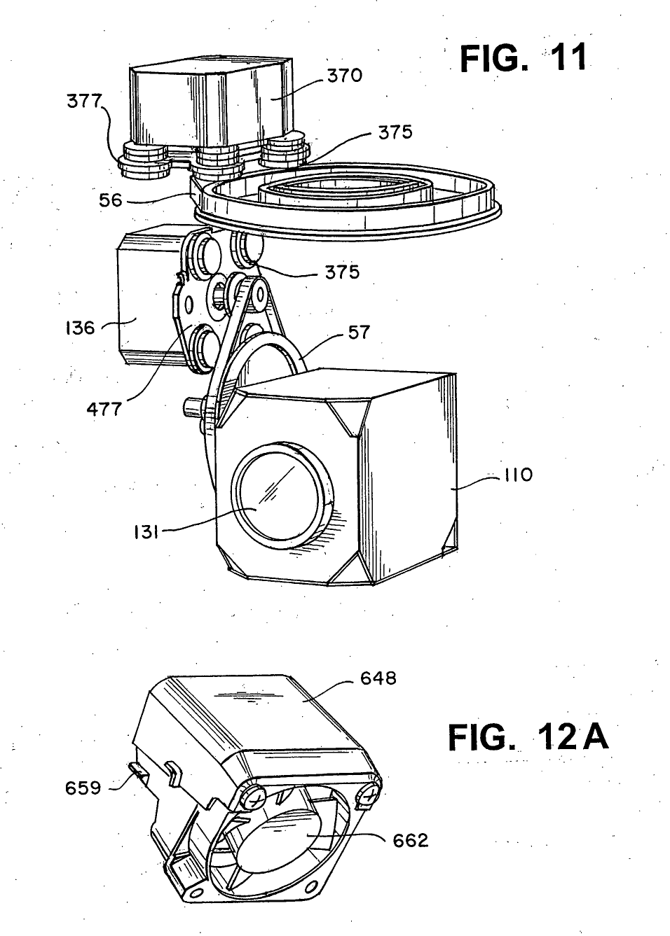

Referring to FIG. 5A-5C, directly below customer interface board 130 rests camera drive 105. FIG. 11 shows camera drive 105 separate from shroud 115 with portions of its outer casing removed for clarity. Camera drive 105 is operable to orientate the camera in 360° azimuth (pan angle) and 180° elevation (tilt angle) and comprises a removably mounted camera 110, pan-and-tilt drives 370, 136 and CPU 206. The panning motor 370 rotates camera 110 about the horizontal axis causing a well-known panning movement of the camera 110, while the tilting motor 136 rotates camera 110 about the vertical axis causing a well-known tilting movement. Camera drive 105 can be removably secured in housing 100 through the use of any available connection means known by those of skill in the art, such as by screws, guide rails, clips, cords, etc. According to a preferred embodiment camera drive 105 is configured for snap-in installation into housing 100.

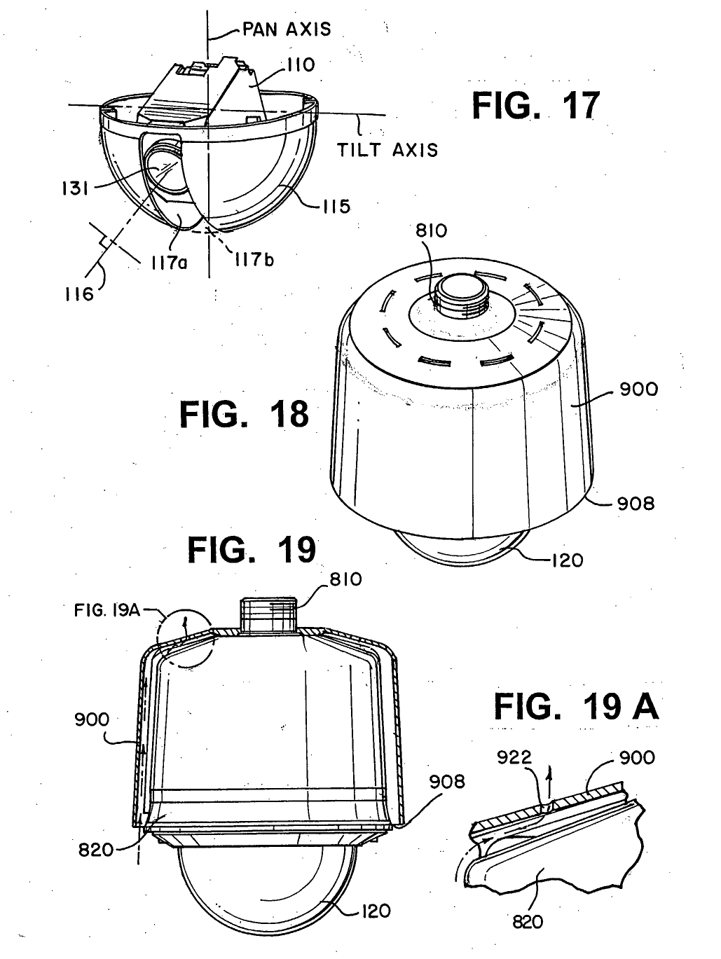

As illustrated in FIG. 1, dome 120 is releasably fastened to housing 100 by a set of four interlocking tabs 121 that may be positioned onto mating supports about the lower rim 122 of housing 100. Interiorly of dome 120 is a further dome-like member or shroud 115 which rotates with camera 110. Shroud 115 is opaque and provides camouflage for camera drive 105 and camera 110, except for a defined viewing region which is aligned with viewing direction 116. The viewing region is in the form of a slot 117a in the shroud which runs from the apex 117b of the shroud vertically circumferentially through an angle of approximately ninety degrees, as is seen in FIG. 17. This permits the viewing direction 116 to be pivoted or tilted from a horizontal position to a vertical position (directed downwardly) for each pan position of surveillance camera 110. Shroud 115 is releasably fastened to camera drive 105, preferably configured for snap-in connection, and as discussed can be textured such as to conceal the position of camera 110.

According to a salient aspect of the present invention, a safety chain or cord 145 including a clip 147 may be provided to keep camera drive 105 loosely attached to housing 100 for servicing, installation or adjustment of the unit. Safety cord 145 can support the weight of camera drive 105 and is useful in preventing mishaps which can occur while installing the camera system, such as accidentally dropping camera drive 105. For similar reasons, another safety cord 146 and clip 148 connect dome 120 to housing 100.

As briefly discussed above, and discussed below in further detail, the surveillance camera system 104 includes a video camera 110 such as model No. VK-S454R camera sold by Hitachi. The video camera is a compact chassis type camera which is designed for surveillance under a wide range of light conditions. Camera 110 includes a lens assembly 131 having controllable lens zoom, focus and iris functions. Camera 110 includes a video sensor (not shown) mounted to the rear of the lens assembly 131 at its focal plane and a camera electronics package for converting sensed images to video signals. Referring to FIG. 17, the lens assembly 131 has an optical axis 116 and camera 110 is removably mounted upon camera drive 105 with its optical axis 116 intersecting the pan axis and transversing tilt axis. In this way, the camera optical axis 116 remains normal to the surface of the dome 120 in all possible pan and tilt orientations of the camera. Further, the center of gravity of the camera 110 and lens assembly 131 is preferably close to the intersection of the vertical pan and horizontal tilt axis such that the camera and lens assembly is kinematically balanced for rapid pan and tilt movement rates. With the camera's center of gravity located closely adjacent the intersection of the pan and tilt axes, high speed camera movements can be made and the camera brought to rather abrupt halts quite smoothly with unperceivable wobbling actions developed by camera 110 and camera drive 105 momentum. These axes are also located so as to intersect at or close to the center of the spherical housing when the camera and camera drive are secured therein. Accordingly, the housing diameter required to accommodate the full range of movement of the camera and drive is minimized such that the smallest possible dome 120 can be used. Further, with this configuration, the camera's optical axis 116 is always oriented substantially normal to the surface of the dome 120 regardless of the camera's orientation with respect to the pan and tilt axes. This serves to minimize some generated image refractions which tend to impede optical quality of the image transmitted to the camera.

A preferred mechanism for rotating camera 110 in 360° pan and 180° tilt, sensing the exact direction in which the camera is pointed and enabling rapid recalibration of the camera unit is provided in U.S. patent application Ser. No. 10/312,457, filed Jun. 22, 2001 entitled Dome Housed Video Camera Assembly with 180 Degree Tilt Motion, the entirety of which is hereby incorporated by reference and therefore, not described in full detail. Additionally, video camera 110 is conventionally provided with power terminals for connecting the camera with electrical power and with video input and output terminals for receiving and outputting video and control signals from and to a local CPU and a remote computer.

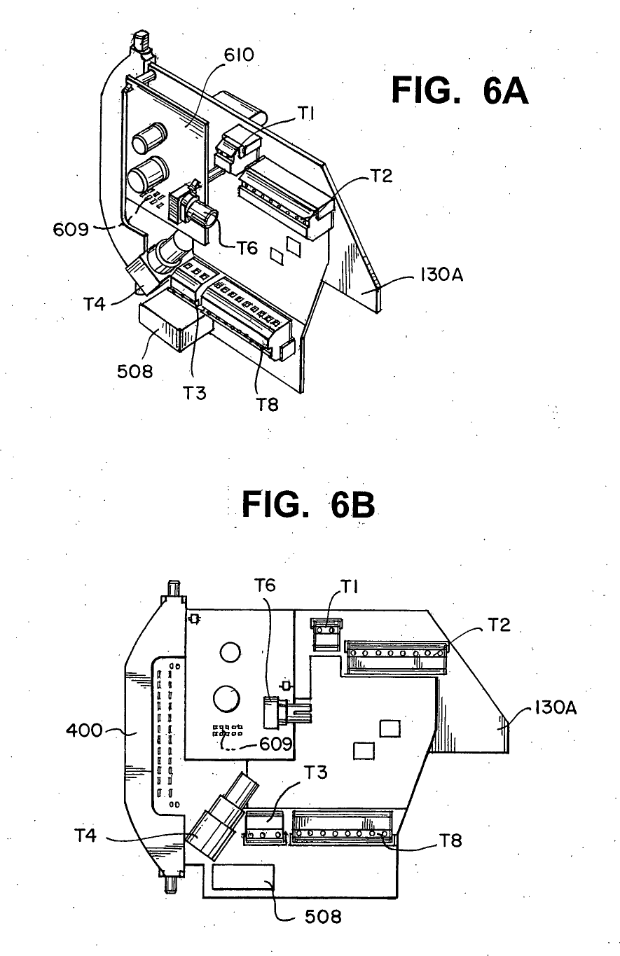

Referring to FIG. 6A-6B, customer interface board 130 comprises inputs for power T1, alarms T2, relay/control signals T8 and video signals via coaxial cable input T4, UTP input T3 or fiber optic input T6. Alarm input signals 215 and relay output signals 220 are carried on individually-shielded twisted pair cable sets. Relay output signals drive external devices, e.g., a light can be turned on and off when the relay output is connected to the light circuit. Alarms are electronic CMOS level type inputs that are driven by a contact type switch with two states, open and closed. For example, a switch connected a door of a building can trigger an alarm when connected to the alarm input T2 and the door is opened.

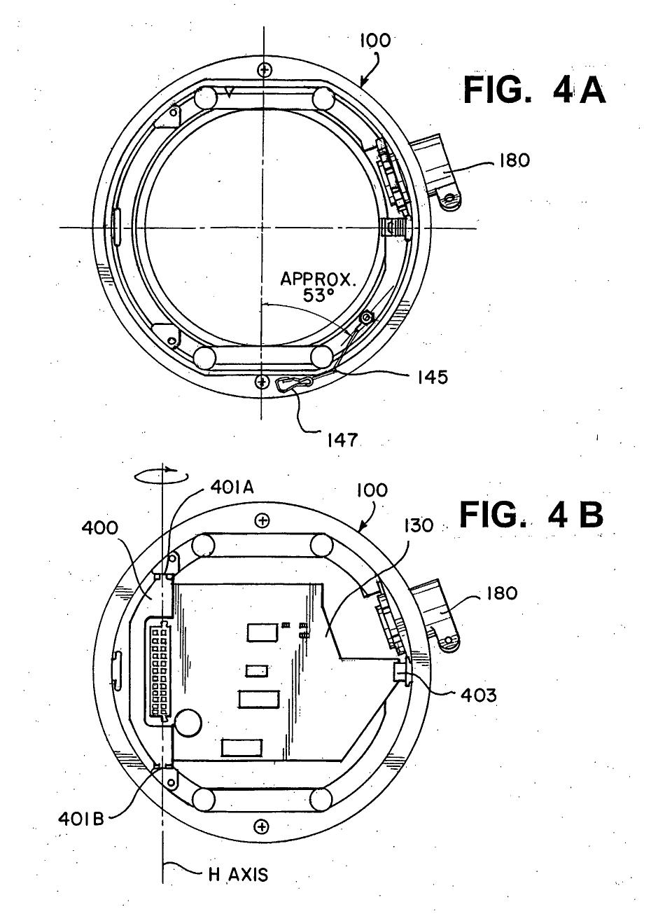

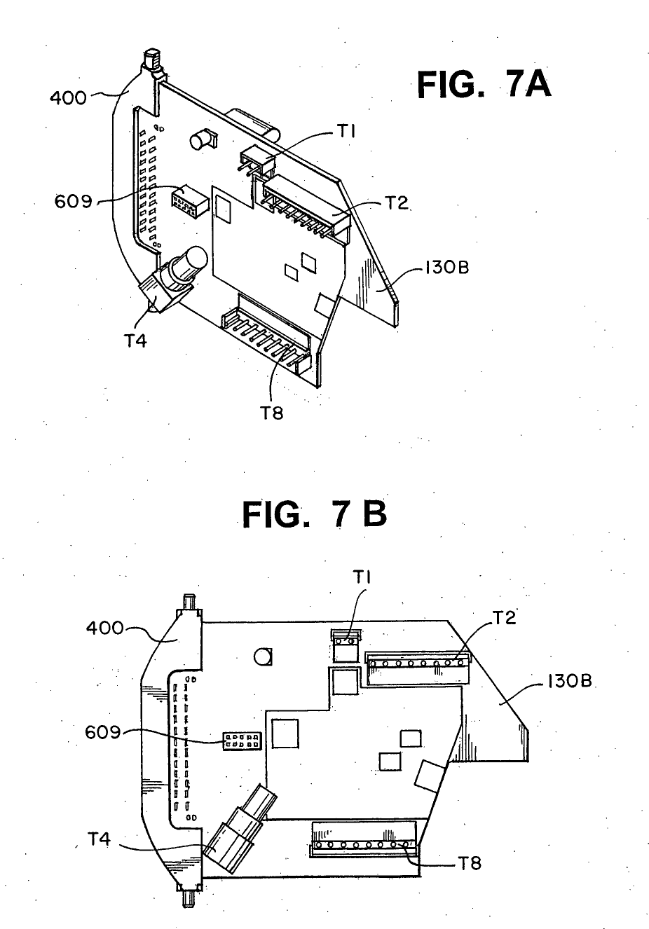

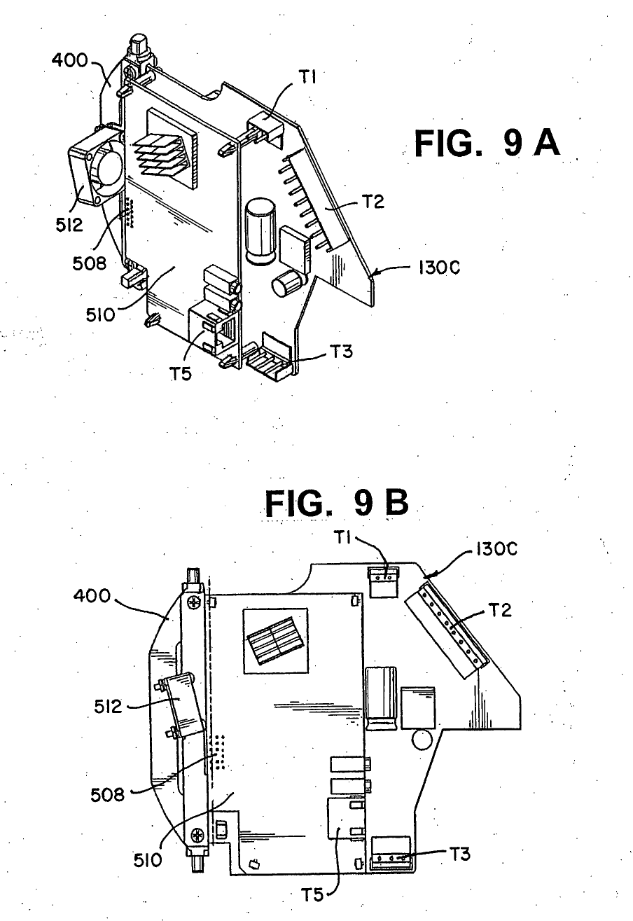

According to a preferred embodiment of the present invention, surveillance camera system 104 can be configured to accommodate alternative video configuration interfaces, i.e., coaxial cable, fiber optic, twisted-pair, IP. As shown, this can be accomplished by a single customer interface board 130 comprising multiple video interface options to accommodate the available video transmission medium present at the installation site or by multiple interchangeable customer interface boards 130 each configured for a different video configuration (see FIGS. 7-10). FIGS. 4A-4B, illustrates an inner and outer view of the top wall of housing 100. Housing 100 includes hinge apparatus 400 and board retention means 403 for supporting customer interface board 130. As shown, customer interface board 130 is pivotally attached inside housing 100 by hinge 400. Hinge 400 includes pivotal connection points 401A, 401B enabling rotation of customer interface board 130 about the hinge-axis H. Board retention means 403 is preferably a tab configured to releasably secure customer interface board 130 proximate the top inner wall of housing 100. In the event that replacement of customer interface board 130 is required during installation or updating of surveillance camera system 104 (e.g., changing the video interface option), the camera drive 105 can be detached from housing 100 and left to rest on safety cord 145 while the customer interface board 130 is unlatched from tab 403 and rotated 90° downward to the vertical position. From the vertical position customer interface board 130 can be disconnected from hinge 400, removed from housing 100 and an alternative customer interface board 130 with the appropriately desired video interface option can be installed after which camera drive 105 can be reinserted in housing 100. Alternatively, according to the embodiment of FIGS. 6A-6B, a single customer interface board 130 can be configured to include a plurality of video interface options via connectors T3, T4, T6 and T5 (FIGS. 9A-9B). In this manner, changes in video transmission can be accomplished through accessing a single board by rotating the board to the vertical position and making all necessary connections to the terminal block used for implementing the desired transmission medium.

Once connected to power, alarms, relay and video terminal, the surveillance camera system's 104 video protocols can be configured according to the appropriate video interface employed by setting on-board switch selectable video protocols on camera control board 206 (FIGS. 5A-5B) of camera drive 105. Referring to FIGS. 5A-5B, switches 202 enable configuration of camera control board 206 for a particular communications protocol locally and various alternative communication protocols can be realized by setting the switches accordingly. According to one aspect of the present invention, switches 202 are a plurality of DIP switches having two possible positions: on or off. It should also be realized that according to other aspects of the invention, control board 206 can be configured remotely via a user interface for updating software versions and setting the units address by entering software commands at the remote operating consol as opposed to setting onboard switches.

After all terminal connections with customer interface board 130 have been made and switches 202 on camera control board 206 has been set to configure the on-board video protocols, camera drive 105 can be mounted in housing 100. Camera drive 105 is aligned with housing 100 and guided upward into housing 100 until it snaps into place with connector 298 on camera control board 206 fitting securely with a mating connector on the control interface board (not shown). All communication between camera drive 105 and customer interface board 130 is achieved through control board 206, connection with which is made available by connector 298. Any alignment means conventionally known in the art may be provided for aligning and retaining camera drive 105 with housing 100. For example, camera drive 105 may contain guide grooves on its outer perimeter that mate with ribs on housing 100, or vis-versa. Lastly, dome 120 is attached to housing 100 to complete the installation of surveillance camera system 104. Tabs 121 of dome 120 are lined up with corresponding recesses (not shown) on lower rim 122 of housing 100 and dome 120 is locked into place with the upper edge of the dome 120 flush with ceiling 102.

FIGS. 7-10 show four variations of customer interface board 130 configurations provided to support a different combination of video connections (i.e., coaxial cable, fiber optics, twisted pair, and IP/TCP) in accordance with the present invention. As such, one customer interface board 130A can service more than one video transmission option and need not be replaced every time a system change is required. Referring to FIGS. 6A-6B, coaxial cables carry the composite video signal and control signals out of surveillance camera system 104 through connector T4. According to an alternative arrangement, as opposed to utilizing coaxial cable, customer interface board 130A can also be connected to transmit video over twisted-pair wires connected to terminal T3. Alternatively, if transmission of video data using fiber optic cable is desired, a fiber optic interface module 610 with a standard fiber-optic connector T6 can be connected for communication with customer interface board 130A through connector 609. In this instance, video data is carried through connector 609 on customer interface board 130A to fiber optic interface board 610 and output via a standard fiber optic connect T6. Further still, if network access is desired, a LAN interface module 510 (FIGS. 9A-9B) can be connected for communication with customer interface board 130A through connector 508. Accordingly, video data is carried through connector 508 to LAN interface module 510 and output via terminal T5 of the LAN module. LAN interface board 510 enables customer interface board 130A to transmit video data over TCP/IP and can be controlled locally or remotely, from any location over the internet using a pre-installed network video protocol.

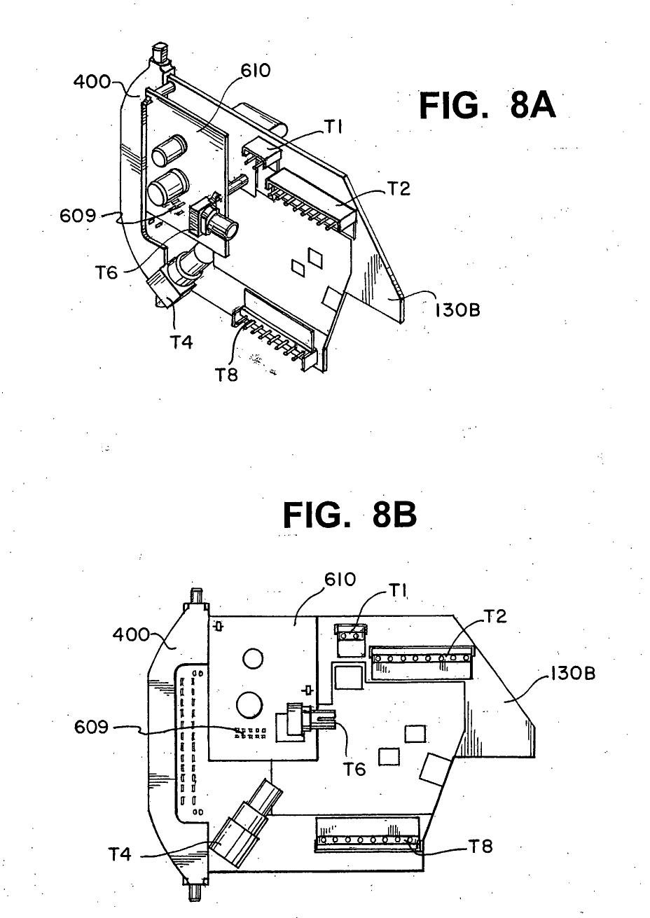

FIGS. 7-10 illustrate an arrangement for four customer interface board configurations embodied by the customer interface boards 130B, 130C and 130D according to a preferred embodiment of the present invention. Referring to FIGS. 7A, 7B, 8A and 8B customer interface board 130B is configured to transmit video data over coaxial cable connected to terminal T4 or fiber optic by the addition of fiber optic interface board 610. If fiber optic transmission is desired, fiber optic interface module 610 can be connected to the customer interface board via connector 609 and terminal T6 on the interface board will support a fiber optic connection. Inputs for power T1, alarms T2, relay/control signals T8 will remain connected to their respective terminals during the change from coax to fiber optic.

Referring to FIGS. 9A-9B, customer interface board 130C is configured to support a network interface via a LAN interface module 510. Video data is carried from customer interface board 130C to LAN interface module 510 through connector 508 and output via terminal T5 of the LAN module. LAN interface board 510 enables customer interface board 130C to transmit video data over TCP/IP and can be controlled locally or remotely, from any location over the internet using a pre-installed network video protocol.

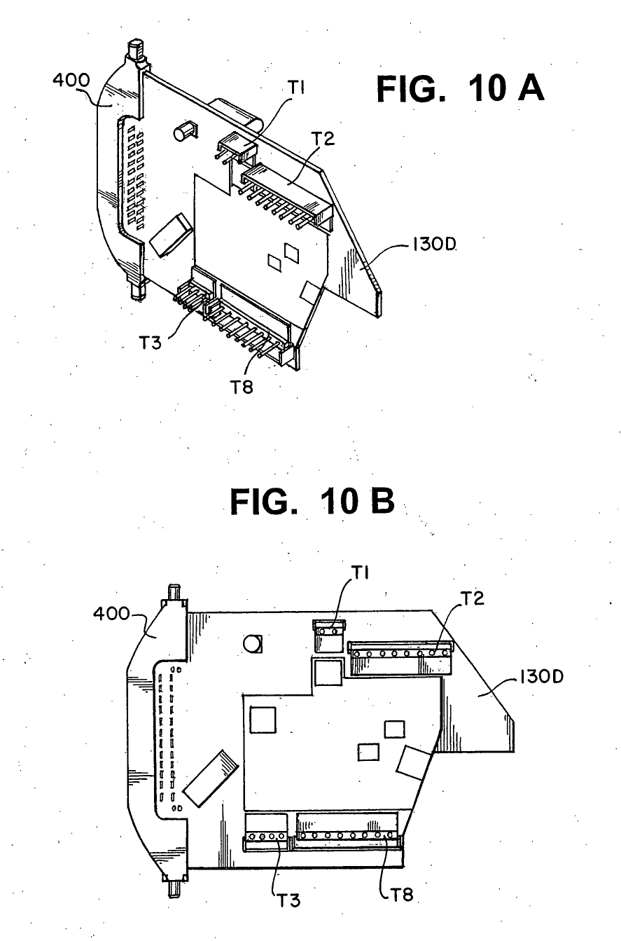

Referring to FIGS. 10A-10B, customer interface board 130C is configured to transmit video data over coaxial cable connected to terminal T4 or twisted-pair connected to terminal T3. If transmission over twisted-pair is desired, customer interface board 130D, like 130a-c, can be pivoted on hinge 400 to the vertical position, twisted pair wires can be properly connected to terminal T3 and board 130 can be locked back into place against the top wall of housing 100. Prior to refitting camera drive 105 in housing 100, the user may be required to set the appropriate switches 202 on the main CPU 206 to configure the video protocol for the UTP transmission. As discussed above with respect to the fiber optic board, all inputs for power T1, alarms T2, relay/control signals T8 will remain connected to their respective terminals during the change from coax to UTP.

In the preferred embodiment of the invention, video data streams are communicated to a computer from several remotely located surveillance camera systems. Ideally, video data streams are transmitted over coaxial cable using customer interface board 130a or 130b. Although a coaxial cable is preferred, the presently existing communications network in the building where the surveillance system is to be installed may support only a fiber optics network or perhaps both fiber optics and coax transmission mediums. Consequently, the surveillance camera system 104 can transmit video data streams over twisted pair wires, coaxial cable or a fiber optics network by accessing the customer interface board, connecting the desired transmission line to the appropriate communications terminal and setting the video protocol on the control board by accessing switches 202. The specific communications protocol employed over the twisted pair, whether POTS, ISDN or ADSL, is not essential because all protocols can be preinstalled on the main board and programmably selected. The details of these protocols are generally known to those skilled in the art and no further discussion is therefore needed or provided herein.

Because the baud rates of remotely located surveillance camera units may not necessarily be known at the time of installation, and indeed can be expected to vary from unit to unit, it has traditionally been necessary to have the installer of a unit perform on-site adjustment of control switch settings. Moreover, where a remotely accessible camera unit contains multiple serial ports, the overall hardware complexity and possibility for error in baud rate and line polarity adjustment for each serial port is substantially increased.

Automatic baud rate detection allows a central monitoring station or remote computer to accept data from a variety of surveillance camera units operating at different speeds without establishing data rates in advance. This allows a surveillance camera to detect a new baud rate from the host computer without having to cycle AC power and is useful when the camera is set up remotely at one baud rate and the host computer configured at a different baud rate. The baud detector determines the speed and logic level of the incoming data stream by examining a character or multi-character string, which is usually a predefined 8-bit command character comprising the camera address and header identifier.

The command may be transmitted with a leading start bit and a trailing, optional parity bit and one or two stop bits. The sequence of bit transmission begins with the start bit, which is followed by the command from the least significant bit (lsb) to the most significant bit (msb), the optional parity bit and then the one or two stop bits. Preferably, all commands are 8 bit characters with a leading start bit, a trailing stop bit and no parity bits. Since most communications lines are tied to a logic high level when data is not being transmitted over the line, the start bit is typically a logic “0”.

Automatic baud rate detection is performed by a software routine executed by a host processor that is associated with the central monitoring station. If the software routine has not previously detected the baud rate, the software routine waits for the user to enter a command for a particular surveillance camera and then transmits it onto the output line. The software routine waits for the echoed command to return on the serial input line and then counts how long it takes for the bits of the command, including the start bit and the stop bits, to arrive on the input line. The software routine then calculates the baud rate that is required for transmitting the data to the remote device, stores the baud rate and initializes various transmit function registers in the serial communications controller to transmit at the required baud rate. Additionally, when a valid command is received by a surveillance camera with a valid address the baud rate and polarity is saved in non-volatile memory.

In one example, the software routine counts how long it takes for the command characters to arrive by reading the input data stream and waiting for it to transition to a logic low level, which is assumed to be the start bit. A timer is started when the data stream transitions to a logic high level again with the lsb of the command. The software routine waits for the remaining bit transitions in the command and stops the timer at the beginning of the first stop bit. The timer value indicates how many clock cycles passed while the software routine waited for the eight data bits plus any optional parity bit.

The advantage of using the camera address and header identifier information for baud rate detection is that if the remote computer is sending commands at various baud rates to several surveillance camera units, each individual camera will only look for commands to its own address and will not lock onto the wrong baud rate. Alternatively, a single byte, i.e., the character “A”, may be used to determine the baud rate as opposed to the 8-bit address and identifier information mentioned above. According to such an alternative arrangement, a surveillance camera can send out an the auto-baud character “A” upon power up or when prompted with a command from the remote computer.

The baud rate on the remote computer is setup via manual programming, e.g., a user at a remote monitoring station programs the baud rate into a keypad by using a sequence of function keys and navigating through a menu system displayed on a local LCD display. An advantage of implementing the above described auto-baud detection feature is that if upon installation of a surveillance camera in a remote location a dip switch setting used to configure the video transmission protocol was mistakenly set to the wrong baud rate this error can be detected and the dip switch setting corrected accordingly. Additionally, polarity control is provided whereby a message will be displayed at the host computer indicating the transmit polarity, e.g., + or −, along with a request to send a command. Thereafter, the transmit polarity can be reversed by issuing an appropriate command from the host commuter. If a framing error is detected, the transmit polarity will revert back to the previous setting.

Referring to FIGS. 15 and 16, surveillance camera systems 860 and 865 comprise camera 110, mounting pipe 406 and housings 800, 820 and look like well-known pendant-mounted domed television cameras. Housings 800, 820 comprise a shell having a shape of a bell or of an acorn cup and a open base 805 to which the doom 120 is attached. Dome 120 is releasably fastened to base 805 of housings 800 and 820 by means of a set of four interlocking tabs 121 that may be rotary positioned onto mating supports about the rim of base 805. Surveillance camera system 860 is preferably configured for use indoors and housing 800 is preferably composed of injection molded plastic. Surveillance camera system 865 is preferably configured for use outdoors in which case housing 820 is composed of diecast aluminum so as to provide added strength and protection to the enclosed camera drive.

Housing 800, 820 comprises threaded upper opening 810 at the center of its top end for connection with mounting pipe 406. Different shapes of pipe 406 are known. For example, pipe 406 can be straight for pendant mounting the surveillance camera system under horizontal structures or it can be formed or bent into L-shape or U-shape for mounting the surveillance camera system on vertical structures such as walls. Upper opening 810 is threaded into mounting pipe 406 using a well-known plumber's sealant tape or pipe lubricant/sealant to ensure that water will not leak into the surveillance camera system 860, 865. It becomes clear that the surveillance camera systems 860, 865 having a shape of an acorn and comprising the camera 110 mounted onto the base 805 of housing 800 can be mounted outdoors exposed to rain or snow and that water will not leak into the camera, the pipe or the upper opening assembly.

FIG. 16 shows an outdoor surveillance camera system 865 particularly equipped for extreme temperature and weather conditions. While similar to the arrangement of FIG. 15, surveillance camera system 865 further comprises an outdoor cover 900. Outdoor cover 900 is attached to housing 820 and is effective to deflect heat energy, dissipate heat energy not reflected, and enable a high level of heat dissipation even when the camera is operated in sunlight at high ambient temperature. Outdoor cover 900 surrounds housing 820 completely, provides protection from radiant heat energy for the housing 820 and the surface itself is specified so that the emissivity is such that it reflects or deflects most of the radiant heat energy from the sun or any other hot body.

Cover 900 performs multiple functions including providing additional protection for camera housing 820 and enclosed camera drive 105 by reflecting and removing radiant heat energy. Cover 900 also provides the means of preventing water from adhering to the dome 120 by providing a drip edge 908. Cover 900 has vents 922 in a top portion that allow hot air to escape. Water that penetrates vents 922 is directed along its inner surface and exits the cover 900 at the open drip edge 908. Additionally, cover 900 may further include water channels on its inner surface (not shown) for directing water from vent slots 922 outward from cover 900.

Outdoor cover 900 preferably functions as a sunshield for minimizing radiation heating of surveillance camera system 865. Unlike conventional pendant mounted dome television camera's the present invention provides vent slots through the ceiling of outdoor cover 900 and a passageway exiting through the bottom of the cover to minimize heat build up in the air gap between the housing 820 and the cover 900. As illustrated in FIG. 18, this sets up natural convention air paths and has the added benefit of providing additional cooling to housing 800 and its internal components. Dissipation of thermal energy through cover 900 is achieved by air moving through the air passage formed between the housing 820 and the cover 900 and upward through vents 922. Under ordinary circumstances, convection will result in an upwardly moving air flow pattern which assists in dissipating thermal energy through the vents.

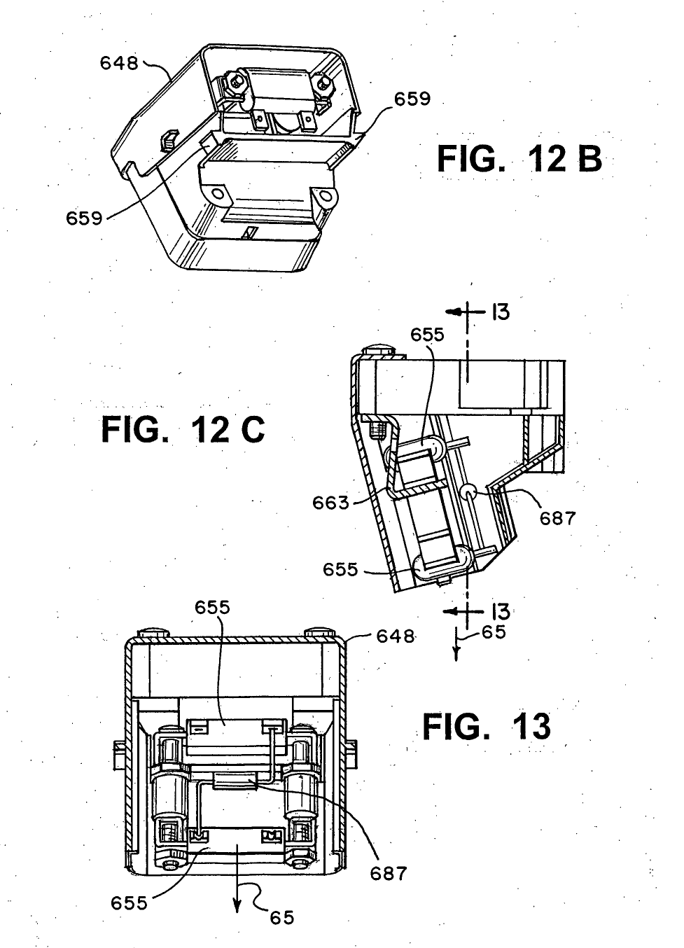

Referring to FIGS. 5A-5C and 16, camera drive 105 has the ability to accept a fan heater 648 for low temperature applications, without the use of additional hardware for installation. Heater 648 enables safe and efficient use of a video surveillance camera in an outdoor location over a wide range of ambient temperature and weather conditions. Preferably, heater 648 is configured for a snap-in fit with camera drive 105. Shown independently in FIGS. 12A-12C and 13, heater 648 has a compact form, and is configured to occupy not more than one-half, and preferably not more than one-sixth of the circumference of the housing 820. Resistor heater elements 655 are disposed in fan heater 648 and mechanically fastened to mounting bracket 663. The placement of the heating elements 655 in the assembly 648 assures that the air flow 65 will flow over both sides of heating element 655, assuring maximum efficiency in heating the air, when heating is required. Fan heater 648 includes an inline thermal fuse 687 for providing over-temperature protection for resistive heating elements 655. Fuse 687 responds to temperature by interrupting the electrical circuit when the operating temperature of heating elements 655 exceed the thermal rating of the fuse.

According to a preferred embodiment, heater 648 is configured for snap-fit attachment with camera drive 105 via side flanges 659 such that it can be conveniently connected and disconnected as necessary. Side flanges 659 can be supplemented by retaining clips 657 (FIGS. 5A-5C) on camera drive 105 which can be bent against the side walls of heater 648 and secured into position between flanges 659. Alternatively, heater 648 can be secured to camera drive 105 with the use of screws or other appropriate fastening means allowing its removable attachment to the camera drive. When this assembly is connected to camera drive 105 as shown in FIG. 16, operation of fan 662 provides air flow between camera drive 105, housing 820 and dome 120. The air flow pattern provides substantially even distribution of heat within the sealed chamber formed between housing 820 camera drive 105 and shroud 115. Thermal energy in the circulating air flow engages the walls of housing 820 and dome 120, enabling thermal energy to be conducted therethrough and dissipated from the surveillance camera system 865 through the wall of housing 820. According to a salient aspect of the present invention, dissipation of heat generated by heater 648 is achieved through the air moving between the housing 800 and the cover 900 and upward through vents 922.

In cold ambient conditions, operation of the heater 648 can prevent formation of ice and frost on the dome 120, which would interfere with operation of the video camera 110. Fan heater 648 is preferably automatically controlled by a thermostat, preferably a solid state control, which can be connected to control board 206 and mounted in camera drive 105 or housing 820 and which can enable the video camera to operate properly over a temperature range of approximately −40° C. to approximately +55° C. The control circuit can be responsive to temperature inside the enclosure and can also be responsive to temperature outside the enclosure, for example responsive to solid state temperature sensors. Such solid state controls and sensors are known in the art, and are omitted for purposes of clarity.

Referring to FIG. 5A-5C, fan 372 is operable to circulate the heated air output by heater 648 when the heater is turned on or to circulate cool air about camera drive 105 when the camera drive is under warmer conditions. The speed of the fan is set as a function of the temperature of control board 206 temperature using a sensor or sensors (not shown) connected to board 206. The maximum temperature read from a sensor is written to flash memory only when the camera's pan, tilt and zoom functions are inactive so that interrupts do not have to be disabled when writing to flash.

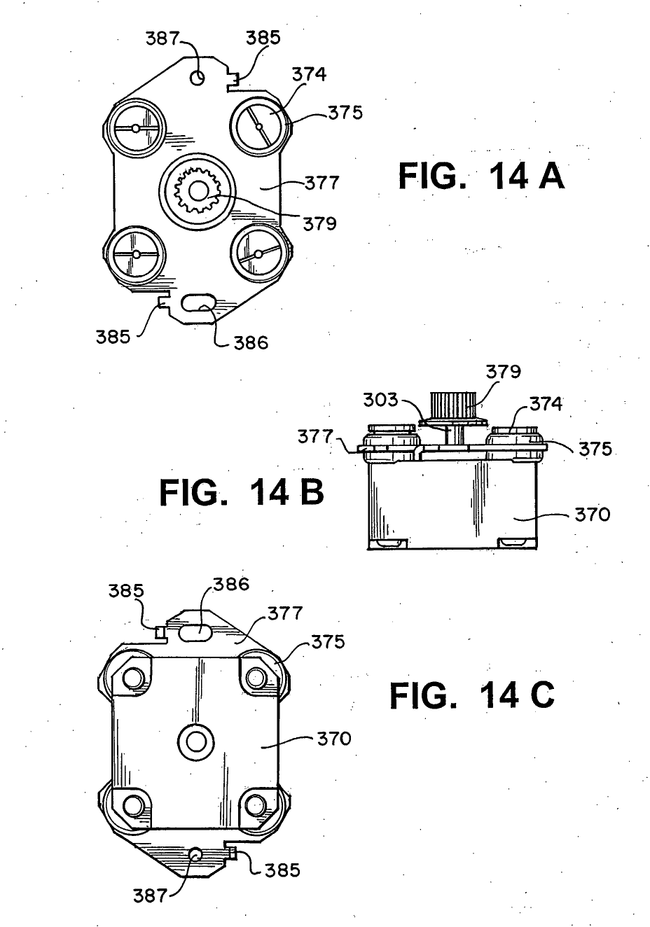

Camera drive 105 comprises a pan and tilt assembly, generally designated as 55 (FIG. 11) and a dome controller which is embodied in control board 206 of FIGS. 5A-5C. Referring to FIG. 11, the pan and tilt assembly 55 includes a pan motor 370, which is preferably a step motor, isolated from a pan motor platform 377 via rubber ring bumpers or spacers 375. Spacers 375 are disposed between the pan motor 370 and the pan motor platform 377 to provide vibration isolation between the motor and platform. Spacers 25 also provide vibration isolation between motor 370 and housing 100. Pan and tilt assembly 55 is fixedly attached within camera drive 105 by securing platforms 377 and 477 of the respective pan and tilt motors, 370 and 136, to the camera drive apparatus. As shown in FIGS. 14A-14C, platform 377 is includes tabs 385 operable to secure the pan motor assembly with camera drive 105.

Pan motor 370 includes a shaft 303 that passes through the pan motor platform 377 and extends to the underside of the platform. A gear 379 is affixed to the pan-motor shaft. A timing belt 56, shown in phantom, mechanically couples gear 379 to drive a second gear 40 which is rotatably mounted to a portion the camera drive housing 105. Camera 110 is mounted to the apex of gear 40 such that rotation of the gear 40 will cause the camera to rotate about the pan axis. Because gear 379 of pan motor 370 drives gear 40, camera 100 is essentially driven by the pan motor 370. Gear 40 has an annular bearing (not shown) mounted in the center thereof to permit relatively unrestricted rotation of the gear when being driven by the pan motor 370. Furthermore, a solid shaft is used for mounting gear 379 to the pan motor platform 27.

Spacers 375 are preferably formulated to be indifferent to temperatures in the range of −40° C. to 60° C. Additionally, spacers 375 help compensate for differential thermal expansions or contractions that may occur in timing belts 56 and 57. Timing belts 56, 57 with negative thermal coefficients of expansion can have adverse effects on a motor drive system having a positive thermal coefficient. Specifically, the belt tension will vary with temperature and may cause the pan and tilt motor to stall under the increased belt tension. Spacers 375 can minimize these effects. In addition to dampening motor noise, they will act as springs minimizing the variation in belt tension with temperature variation and ultimately resulting in less maintenance of the camera drive system due to complications resulting from the thermally induced loads and relaxation of the timing belts. Belt tension adjustment provided by pivoting about hole 387 (FIGS. 14A-14C) in platform 377.

Turning now to the software aspects of the system, the surveillance camera system in accordance with the principles of the present invention also includes an image masking system. The image masking system acts to modify a displayed image corresponding to the video signal so as to partially or totally obscure or blank the image areas or portions corresponding to one or more preselected privacy zones or masks. In accordance with the invention, a remote host computer or central control unit of the system and software programming of therein are adapted to control image masking. This control is effected based on pan, tilt and zoom coordinates associated with the privacy mask location.

Each surveillance camera views an area of a location which is in the Field Of View (FOV) and along the viewing axis of the assembly. Each image is converted by the respective camera and lens assembly into an electrical video signal which is supplied to a monitor of the remote operator console over the video communications channel.

The remote operator console includes a microprocessor unit, a random access memory (RAM), a FLASH memory, an encoder, a communication interface circuit and power supply. The communications interface provides bi-directional, serial communications between the operator console and a surveillance camera unit. Commands are sent to the surveillance camera unit based on operator input at the console. This input can be by a joystick, keyboard or other user control option.

The remote operator console also supports a text overlay unit through which the electrical image signal passes before being displayed on the monitor. The text overlay unit, under control of the microprocessor and the software programming, generates an electrical signal containing text image information and adds the text electrical signal to the image electrical signal. This results in desired text images being overlayed on the video image so as to be visible to the operator on the monitor. These text images may include menu information and real-time status information concerning the assembly.

In accordance with the principles of the present invention, the remote operator consol is further adapted to define and establish areas of the viewed video image corresponding to desired privacy zones which are to be concealed (masked) from view. In these areas, the video image is partially or totally blanked so that it is sufficiently obscured so as not to be visible or discernable to the operator viewing the video image on the monitor of the console. More particularly, these areas are established via the microprocessor and its software programming, in conjunction with an image mask, which in the present embodiment is formed by the text overlay unit.

According to a preferred embodiment, a text overlay unit connected to the remote operation consol is used to develop the privacy mask. In particular, the text overlay unit is controlled by the host computer and software programming to generate a text overlay signal corresponding to blocks of semi or non-transparent characters defining an image corresponding to the privacy mask. When this overlay signal is added to the displayed image on the on screen display, the non-transparent image areas are overlayed on and totally or partially blank the associated viewed image areas. These areas (privacy zones) thus become obscured and are no longer discernible or viewable. In accordance with the invention, these image areas are established based upon defining triangular masking areas of the image.

In further accord with the invention, the operator at the central location can communicate with the surveillance camera to establish the mask image areas (masks). These masks are established based on the pan, tilt and zoom information of the surveillance apparatus and are stored as non-transparent text block characters in RAM memory at either the camera's or the host computers microprocessor. They are called from RAM memory by the microprocessor and programming software and fed to the text overlay unit which combines the masks with the video image information during viewing of the scene on the on screen display.

As can be appreciated, the text overlay unit, due to its ability to overlay text images on the video image, can act to mask the video images in areas where the text appears. By using blocks of semi or non-translucent or transparent characters generated by the unit, semi or non-translucent or transparent shapes can be established which tint or mask out areas of the video image. By placing these masks over the video image corresponding to the privacy zones, the video image will be partially or totally obscured in these areas, thereby concealing from sight any video images in the privacy zones.

Using this capability, the microprocessor and its software programming can control the text overlay to establish and maintain the desired privacy masks. This is accomplished based on the pan, tilt and the zoom conditions of the surveillance camera and the information as to the areas of the viewed image defining the privacy masks.

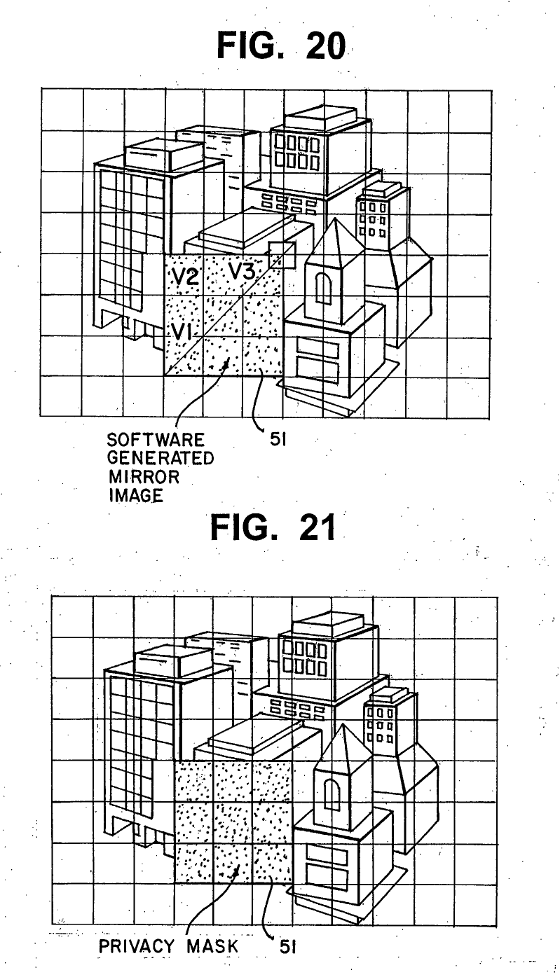

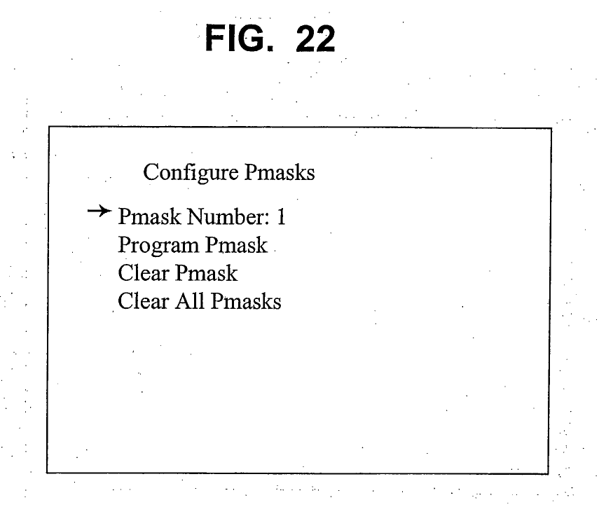

FIGS. 20-21 show the establishment of one such privacy mask 51 for a viewed video image on the on screen display. This is done by the operator first selecting the Program Privacy Masks item from a provided menu interface (e.g., “Program Pmask,” FIG. 24). The operator marks three vertices to define the outer bounds of the privacy mask desired. Specifically, the programming software displays a cross-hair or other indicia in the center of the screen. The operator pans and tilts the surveillance camera until the cross hair is placed over the position defining a first vertex of the privacy mask. The operator then instructs the software programming to save that vertex (V1). The operator then repeats this operation for the other two vertices (V2, V3). A triangular shape is used, as this shape provides the least number of definition points to encompass an area.

When all three vertices are defined, and unless an error condition is triggered and displayed indicating the privacy mask is too small or too large or the focus to far, the operator removes the cross-hair from the screen. Based on this vertex information, the programming software constructs a privacy mask and stores it in the flash memory. In particular, the software constructs a parallelogram shape, for the privacy mask by mirroring the vertex with the widest angle against the triangle's longest side, as shown in FIGS. 20-21. The coordinates of the area of the viewed image defined by the parallelogram are stored in a table in the flash memory as the privacy mask information. The data in this table is then used by the text overlay unit when the on screen display displays the video image to determine the text character block and whether is should be semi or non-transparent to mask the video image corresponding to the privacy zone.

More particularly, during the operation of the surveillance camera system, as the surveillance device is being panned and tilted by the operator, the programming software determines first whether any privacy masks have been enabled and defined for the surveillance device. If the operator has enabled privacy masks and there are privacy masks defined, the software programming then checks the current viewing coordinates to determine whether a privacy mask is to be used to blank an area of the video image. To this end, the software programming compares the coordinates of the mask stored in the flash memory against the current displayed image field of view (FOV). If one or more masks fall within the current FOV, the programming software marks those masks as visible.

If any privacy mask is marked as visible, the locations of text character blocks of the text overlay unit are checked against the coordinates of the relevant masks. A determination is then made as to whether the coordinates of a defined masks encompass one or more text character blocks. For each text character block or portion of text block that falls within the coordinates of the defined mask, text overlay unit changes the block's attribute from transparent to partially or totally non-transparent. For the mask established in FIG. 20, this results in blocking of the video image defined by the mask. This is shown in FIG. 21.

As the surveillance device continues to pan, tilt and/or zoom, the programming causes changes in the pan, tilt or zoom coordinates to be monitored. In particular, the programming causes the current pan and tilt angles to be obtained for the surveillance camera. The zoom magnification is also obtained. The software programming then converts this data from the X-Y coordinate space of the surveillance camera to the coordinates of the camera's FOV. The software programming then compares the current data with the previously saved data and if there is any change, the new data is stored and a differential FOV is calculated.

The changes in FOV are then applied by the software programming to redefine the text character blocks defining the one or more privacy masks. In particular, a text character block is moved right or left for changes in pan angle and up or down for changes in tilt angle. The size of the block is also changed for changes in zoom magnification. This keeps the text character block in the proper image area of the privacy mask and prevents the operator from viewing this image area. This process is repeated as the surveillance device continues to be operated so as to maintain the privacy masks concealed at all times.

As can be appreciated, the text overlay unit, which can be formed from a text display microchip, must support a character background transparency or opaqueness attribute. This requires the turning on and off of this attribute on a per character basis. The unit must also support character color or border attributes so that the characters remain visible regardless of their background transparency settings. Moreover, it is preferable that the on-screen display of the unit be able to completely and uniformly mask the entire area of the video image. The character size must also provide suitable granularity to allow selectively masking parts of a video frame. Depending on the used video format the size of a single character of the unit should likely be less than 16 by 16 pixels. Using the on screen display of the remote operator consol to create and manipulate the privacy masks provides for the availability of the masks essentially independent of the specific camera model included in a surveillance camera dome. Additionally, the resolution of the privacy masks can be as high as the resolution of the on screen display. For example, an on screen display with a character set of 24 (across)×12 (down) would provide for a privacy mask with this resolution.

We claim:

1. A surveillance camera system 104 for use with closed-circuit television systems for capturing real-time images of a selected area and transmitting the images to a remote operating consol for viewing by an operator, comprising:
a housing 100 having a top wall and an opened bottom;
a video communication board 130 pivotally and removably mounted inside of housing 100 and configured to support a plurality of communication or video interfaces;
a locking means for securing the video communication board 130 against the top wall of the camera housing when in a locked position;
a camera drive 105 removably secured in the housing 100 and located directly below the video communication board when in the locked position, the camera drive operable to orientate a video camera in 360° azimuth and 180° elevation, and comprising a removably mounted camera 110, pan-and-tilt drives 370, 136 and a CPU 206;
a hemispherical, translucent dome 120 of an acrylic material releasably fastened to the housing 100 and enclosing the camera 110;
a shroud 115 mounted interiorly of the dome 120 which rotates with the camera 110;
wherein the video communication board allows access to the plurality of communication or video interfaces when the board is in an unlocked position.

2. The surveillance camera according to claim 1 wherein the video communication board comprises an input for power, alarm signals, relay signals, control signals and video signals; and
said video signals input via at least one video interface consisting of the group of coaxial cable, fiber optic, twisted-pair and IP.

3. The surveillance camera system according to claim 1 wherein the video communication board comprises a plurality of video interfaces.

4. The surveillance camera system according to claim 1 further comprising a pair of locking flippers 125 for securing the housing 100 to a ceiling 102.

5. The surveillance camera system according to claim 1 wherein the housing comprises support rails 205 for attaching the camera system onto an inner surface of a ceiling 102 to distribute the weight of the camera system 104 along the length of the rails 205 and the ceiling.

6. The surveillance camera system according to claim 1 further comprising a mounting ring 204 connected between the rails 205 and the housing 100 to support and distribute the weight of the camera system 104 and/or to assist in connecting the rails 205 to the housing 100.

7. The surveillance camera system according to claim 1 wherein the camera drive is configured for snap-in and out connection with the housing 100.

8. The surveillance camera system according to claim 1 wherein the shroud 115 is opaque and provides camouflage for the camera drive 105 and the camera 110, except for a defined viewing region which is aligned with a viewing direction 116 of the camera.

9. The surveillance camera system according to claim 1 wherein the shroud is releasably fastened to the camera drive 105 and is textured such as to conceal the position of the camera 110.

10. The surveillance camera system according to claim 1 further comprising a cord or chain 145 for loosely attaching the camera drive 105 to the housing 100, the cord supporting the weight of the camera drive 105.

11. The surveillance camera system according to claim 1 wherein the camera is a compact chassis type camera designed for surveillance under a wide range of light conditions and comprises:
a lens assembly 131 having controllable lens zoom, focus and iris functions;
a video sensor mounted to a rear of the lens assembly 131 at its focal plane; and
a camera electronics package for converting sensed images to video signals,
wherein the camera has an optical axis 116 which remains normal to a surface of the dome 120 in all possible pan and tilt orientations of the camera.

12. The surveillance camera system according to claim 11 wherein the center of gravity of the camera 110 and lens assembly 131 is located at an intersection of the vertical pan and horizontal tilt axes such that the camera and lens assembly is kinematically balanced for rapid pan and tilt movement rates; and
wherein the camera's optical axis 116 is always oriented substantially normal to a surface of the dome 120 regardless of the camera's orientation with respect to the pan and tilt axes.

13. The surveillance camera system according to claim 1 further comprising a central monitoring station including a host computer, said host computer executing a software routine operable to automatically detect a baud rate of the camera.

14. The surveillance camera system according to claim 1 wherein:
the dome is releasably fastened to the base of the housing by mating tabs disposed on each of the dome and the base.

15. The surveillance camera system according to claim 1 further comprising:
a threaded mounting pipe for mounting the surveillance camera system under or adjacent wall and ceiling structures;
wherein the housing comprises a threaded opened top to mattingly receive the mounting pipe and create a water resistant seal between the pipe and the housing, and
wherein the housing is composed of injection molded plastic or diecast aluminum.

16. The surveillance camera system according to claim 15 further comprising:
an outdoor cover attached to the housing which functions as a sunshield for minimizing radiation heating of the surveillance camera system, the cover is configured to deflect heat energy, dissipate heat energy not deflected, and enable a high level of heat dissipation even when the camera is operated in sunlight at high ambient temperature;
wherein the cover surrounds the housing completely, provides protection from radiant heat energy for the housing, and the surface of the cover is specified so that the emissivity is such that it reflects or deflects most of the radiant heat energy from the sun or any other hot body.

17. The surveillance camera system according to claim 16 wherein the cover provides a means for preventing water from adhering to the dome.

18. The surveillance camera system according to claim 17 wherein the means for preventing water from adhering to the dome is a drip edge on the cover.

19. The surveillance camera system according to claim 16 wherein the cover comprises vented slots providing for the dissipation of thermal energy from within the cover and channels in fluid communication with the slots for directing water from the vented slots 922 outward from cover 900.

20. The surveillance camera system according to claim 19 wherein the vented slots are on a ceiling of the cover and the channels provide an exit for the passage of air and water through a bottom of the cover.

21. The surveillance camera system according to claim 20 wherein the channels minimize heat build up between the housing and the cover thereby providing additional cooling to the camera and camera drive, and allow for natural convention air paths between the housing and the cover.

22. The surveillance camera system according to claim 1 wherein the camera drive comprises a heater to prevent formation of ice and frost on the dome, said heater comprising:
resistive heating elements;
an inline thermal fuse for providing over-temperature protection, wherein the fuse responds to temperature by interrupting an electrical circuit when the operating temperature of the heating elements exceed the thermal rating of the fuse; and
the heater configured for a snap-in fit with the camera drive wherein the heater occupies not more than one-sixth of the circumference of the housing.

23. The surveillance camera system according to claim 1 wherein the camera drive comprises a fan heater to prevent formation of ice and frost on the dome, said fan heater automatically controlled by a thermostat connected to the control board.

24. The surveillance camera system according to claim 23 wherein:
the fan heater operates over a temperature range of −40° C. to approximately +55° C.; and
the fan heater is responsive to temperature variations both inside and outside the camera system via the use of solid state temperature sensors.

25. The surveillance camera system according to claim 22 wherein:
the heater comprises a fan having variable speed settings, said fan operable to circulate the heated air output by the heater;
the control board comprises at least one temperature sensor for reading the temperature of the control board, wherein the temperature read from a sensor is written to flash memory only when the camera's pan, tilt and zoom functions are inactive such that no interrupts have to be disabled when writing to the flash memory; and
the speed of the fan is a function of the temperature of the control board.

26. The surveillance camera system of claim 1 wherein the camera drive comprises:
a timing belt mechanically coupled to the camera drive; and
a fixedly attached pan and tilt assembly, said pan and tilt assembly having a pan motor and a pan motor platform isolated from the pan motor by a plurality of rubber ring spacers, said spacers disposed between the pan motor and the pan motor platform for providing vibration isolation between the motor and the platform, and, between the motor and the housing.

27. The surveillance camera system of claim 26 wherein the spacers dampen motor noise, compensate for differential thermal expansions or contractions in the timing belt, act as springs minimizing the variation in belt tension with temperature variation, and are indifferent to temperatures in the range of −40° C. to 60° C. [I moved the shortest phrase to the beginning to help clarify that it's a list.]

28. The surveillance camera system of claim 1 further comprising:
a remote host computer having a software program capable of image masking,
wherein said software program acts to modify a displayed image corresponding to the video signal so as to partially or totally obscure or blank at least one area of the image corresponding to one or more preselected privacy zones or masks; and
wherein the host computer controls image masking based on pan, tilt and zoom coordinates associated with the privacy mask location.

29. The surveillance camera system of claim 28 wherein the remote host computer comprises:
a monitor; and
a text overlay unit through which the video image passes before being displayed on the monitor for overlaying desired text images on the video image, wherein the text overlay unit generates an electrical signal containing text image information and adds the text electrical signal to the video image.

30. The surveillance camera system of claim 29 wherein the text images include menu information and real-time status information concerning the camera system.

31. The surveillance camera system of claim 30 wherein:
the host computer is adapted to define and establish a mask corresponding to a desired privacy zone which is to be concealed from view; and
the host computer applies the mask to the video image such that the video image is partially or totally obscured by the mask, wherein said obscured portion is not visible or discernable to an operator viewing the video image on the monitor of the host computer.

32. A method for defining and establishing privacy zones in a viewed video image which are to be concealed from view, the method comprising the steps of:
generating a text overlay signal for use as a privacy mask corresponding to blocks of semi-transparent or non-transparent characters based on pan, tilt and zoom information of a camera; and
adding the text overlay signal to a displayed image on an on-screen display.

33. The method of claim 32 further comprising the steps of:
storing the text overlay signal; and
calling the text overlay signal from a RAM memory; and
sending the text overlay signal to a text overlay unit, said text overlay unit combining the text overlay signal with the video image during viewing of the scene on the on screen display.

34. A method for updating or changing a video interface for a surveillance camera system by updating a customer interface board 130 comprising the steps of:
detaching a camera drive 105 from a housing 100 of the camera system;
unlocking the customer interface board 130 from a horizontal rest position and rotating the board 90° downward to a vertical position;
connecting an appropriately desired video interface option to the customer interface board; and
reinserting the camera drive in the housing 100.

35. The method of claim 34 further comprising the step of:
after said rotating step and before said connecting step, disconnecting the customer interface board 130 from a hinge 400;
removing the customer interface board 130 from the housing 100; and
connecting an alternative customer interface board 130 with an appropriately desired video interface option to the surveillance camera system prior to reinserting the camera drive in the housing 100.

36. The method of claim 34 further comprising the step of:
after said connecting step and before said reinserting step, configuring video protocols in accordance with at least one video interface of the surveillance camera system, wherein the video protocols are selected using a switch located on a camera control board 206 of the camera drive 105.

37. The method of claim 36 wherein the video protocols are selected using a series of DIP switches having on and off positions.

38. The method of claim 34 further comprising:
after said connecting step and before said reinserting step, configuring video protocols remotely using a user interface, wherein the configuring step comprises: updating software versions and setting an address for the camera by entering software commands at a remote operating consol.
